(19) United States
(12) Patent Application Publication
(10) Pub. No.: US 2012/0159497 A1
(43) Pub. Date: Jun. 21, 2012

(54) ADAPTIVE PROCESS SCHEDULING METHOD FOR EMBEDDED LINUX

(75) Inventors: Dong Hyouk LIM, Daejeon (KR); Yung Joon JUNG, Daejeon (KR); Chae Deok LIM, Daejeon (KR)

(73) Assignee: Electronics and Telecommunications Research Institute, Daejon (KR)

(21) Appl. No.: 13/326,446

(22) Filed: Dec. 15, 2011

(30) Foreign Application Priority Data
Dec. 16, 2010 (KR) 10-2010-0129437

(51) Int. Cl. G06F 9/46

(52) U.S. Cl. 718/102

(57) ABSTRACT

Provided is an adaptive process scheduling method for embedded Linux. The adaptive process scheduling method includes calculating a central processing unit (CPU) occupancy time of each of one or more processes, determining whether or not it is necessary to perform adaptive process scheduling, calculating a predetermined weight to be applied to the CPU occupancy time of each process when it is determined that it is necessary to perform adaptive process scheduling, and applying the predetermined weight and updating the CPU occupancy time of each process when it is determined that it is necessary to perform adaptive process scheduling. Accordingly, the adaptive process scheduling method can improve the performance by omitting an unnecessary context exchange compared to the related art and can dynamically cope with an abrupt increase in the number of processes.

### CLAIM FOR PRIORITY

This application claims priority to Korean Patent Application No. 10-2010-0129437 filed on Dec. 16, 2010 in the Korean Intellectual Property Office (KIPO), the entire contents of which are hereby incorporated by reference.

### BACKGROUND

1. Technical Field

Example embodiments of the present invention relate in general to process scheduling of an operating system, and more specifically, to an adaptive process scheduling method capable of dynamically scheduling processes performed on embedded Linux applied to an embedded device.

2. Related Art

Linux is an operating system (OS) that enables Unix, which is an OS running on large devices, to run on small personal computers (PC) or devices. Linux has advantages that a source code of Linux is free and open to the public, various functions can be added, and porting to various platforms is possible. Thus, Linux is being widely used as an OS of embedded devices.

In embedded Linux widely applied as an OS of embedded devices (Android from Google Inc. and iPhone OS from Apple Inc. are also sorts of embedded Linux), it is important to smoothly perform a real-time application such as a video player or an MP3 player.

A Linux kernel of the related art uses a complete fair scheduler (hereinafter. “CFS”) for the sake of scheduling of general processes. The CFS is a scheduler that was developed focusing on fairness and is appropriate for a system employing a high-performance central processing unit (CPU) such as a server or a desktop system.

However, in an embedded Linux environment applied to an embedded device such as a smartphone, when the number of processes increases, the number of times that the context is exchanged between processes increases in order to keep fairness, and a CPU occupancy time of each process decreases.

In addition, when a large number of processes are simultaneously executed while replaying music or a moving picture, in an existing scheduler, the replay quality of the music or moving picture deteriorates, and noise occurs.

### SUMMARY

Accordingly, example embodiments of the present invention are provided to substantially obviate one or more problems due to limitations and disadvantages of the related art.

Example embodiments of the present invention provide a process scheduling method for embedded Linux capable of improving the performance by omitting an unnecessary context exchange, compared to the related art, dynamically coping with an abrupt increase in the number of processes, and enabling a real-time application to be smoothly performed.

In some example embodiments, an adaptive process scheduling method includes: calculating a central processing unit (CPU) occupancy time of each of one or more processes; determining whether or not it is necessary to perform adaptive process scheduling; calculating a predetermined weight to be applied to the CPU occupancy time of each process when it is determined that it is necessary to perform adaptive process scheduling; and applying the predetermined weight and updating the CPU occupancy time of each process when it is determined that it is necessary to perform adaptive process scheduling.

The CPU occupancy time calculated in calculating the CPU occupancy time of each of one or more processes may be a delta_exe value to be added to a vruntime value which a scheduler manages for each process.

The determining of whether or not it is necessary to perform adaptive process scheduling may include determining that it is necessary to perform adaptive process scheduling when the number of processes running on the embedded Linux abruptly increases to a predetermined number or more during a predetermined time.

The determining of whether or not it is necessary to perform adaptive process scheduling may include determining that it is necessary to perform adaptive process scheduling when the CPU occupancy time calculated in calculating the CPU occupancy time of each of one or more processes is equal to or lower than a predetermined critical value.

The determining of whether or not it is necessary to perform adaptive process scheduling may include determining that it is necessary to perform adaptive process scheduling when the number of times of non-voluntary CPU prior occupation performed on the embedded Linux increases to a predetermined number of times or more during a predetermined time.

The predetermined weight in updating the CPU occupancy time of each process may be a value larger than one (1), and the CPU occupancy time of each process is reduced overall by dividing the CPU occupancy time calculated in calculating the CPU occupancy time of each of one or more processes by the predetermined value larger than one (1).

The adaptive process scheduling method according to the present invention can improve the performance by omitting an unnecessary context exchange compared to the related art and dynamically cope with an abrupt increase in the number of processes.

In particular, the adaptive process scheduling method according to the present invention can enable a real-time application to be more smoothly performed in a system which employs a relatively low-performance CPU and is small in the number of processes to be actually driven such as a smartphone or tablet.

### BRIEF DESCRIPTION OF DRAWINGS

Example embodiments of the present invention will become more apparent by describing in detail example embodiments of the present invention with reference to the accompanying drawings, in which:

FIG. 1 is a flowchart for explaining an adaptive process scheduling method according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Example embodiments of the present invention provide an adaptive process scheduling method capable of reducing a side effect occurring when a plurality of processes are executed and noise occurring when a multimedia file of a high capacity and a high compression ratio such as a video file or an audio file is replayed, which is a problem of the related art, securing an execution time for each process by dynamically adjusting a weight of fairness, which is important in the scheduler of the related art, during execution, and reducing an unnecessary context exchange.

Hereinafter, an adaptive process scheduling method according to example embodiments of the present invention will be described.

A normal process of Linux usually has 40 priority values ranging from −20 to 19, and a time slice value appropriate for each process is allocated according to the priority value.

A time slice is a maximum time during which the process can occupy the CPU. A weight is applied according to the priority value, and thus a process having a higher priority value can use the CPU for a longer time.

The CFS always maintains a vruntime value to which an additional weight is applied for each process.

The vruntime value is a value obtained by accumulating and updating a CPU use time (delta_exec) of each process for each tick. A weight is applied according to the priority value of the process, and thus, for a process having a high priority value, a time of an amount smaller than a used time is accumulated, and for a process having a low priority value, a time of an amount larger than a used time is accumulated.

The accumulation of the vruntime, to which the weight is applied, for each process has the following meaning. The scheduler of Linux guarantees fairness by allowing a process having a smallest vruntime to be selected when a next process is selected at the time of context exchange so that even a process having a low priority value can occupy the CPU for a certain time without starvation of the CPU occupation.

The accumulated weight of the vruntime differs according to the priority value, and thus a process having a high priority value has many opportunities to occupy the CPU.

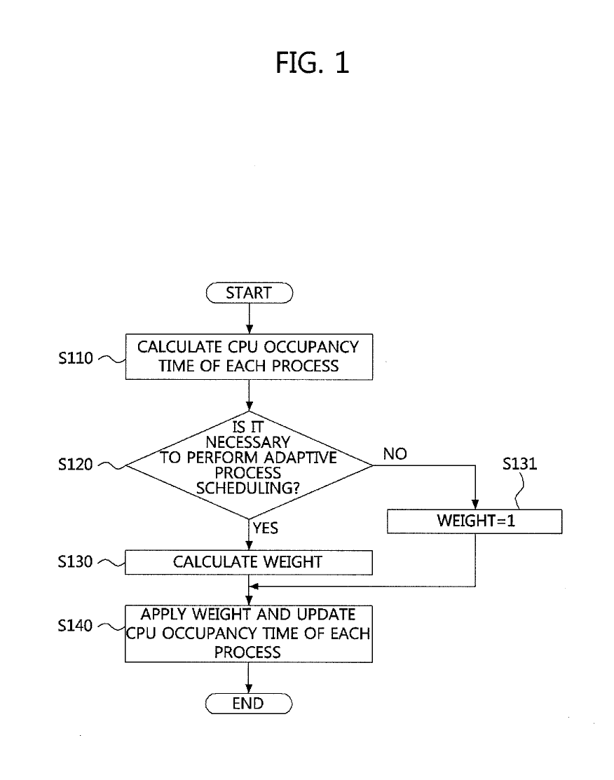

FIG. 1 is a flowchart for explaining an adaptive process scheduling method according to an example embodiment of the present invention.

The adaptive process scheduling method according to an example embodiment of the present invention shown in FIG. 1 may be implemented by revising an occupancy time calculating process of a statistics update portion of a scheduler which is executed for each tick.

Referring to FIG. 1, the adaptive process scheduling method according to an example embodiment of the present invention includes calculating a CPU occupancy time of each of one or more processes (S110), determining whether or not it is necessary to perform adaptive process scheduling (S120), calculating a predetermined weight to be applied to the CPU occupancy time of each process when it is determined that it is necessary to perform adaptive process scheduling (S130), and applying the predetermined weight and updating the CPU occupancy time of each process when it is determined that it is necessary to perform adaptive process scheduling (S140).

First, in operation S110, the CPU occupancy time of each process refers to a delta_exec value that is to be added to a vruntime value which the Linux scheduler manages for each process as described above. That is, the scheduler performs a process of calculating the CPU occupancy time (delta_exec) to be added to the vruntime of each process for each tick.

Next, in operation S120 of determining whether or not it is necessary to perform adaptive process scheduling, it is determined that it is necessary to perform adaptive process scheduling when one of the following three situations occurs.

In a first situation, the number of processes running on an operating system abruptly increases, possibly in an abrupt increase of >100 or >1000. For example, when a predetermined number (for example, 30) of processes increase during a predetermined time (for example, 5 seconds), it is determined that the number of processes has abruptly increased.

In a second situation, an average occupancy time (vruntime) of each process updated for each tick decreases, and it may be the same situation as when the number of processes increases.

In a third situation, the number of times of non-voluntary CPU prior occupation increases, which may mean that an unnecessary context exchange between processes is frequently performed. For example, when non-voluntary CPU prior occupation occurs a predetermined number of times or more during a predetermined time, it is determined that it is necessary to perform adaptive process scheduling.

In any of the above three situations, it is determined that an unnecessary context exchange is frequently performed, and thus in operation S130, a predetermined weight to be applied to the CPU occupancy time (delta_exec) to be dynamically applied to the vruntime is calculated.

However, when it is determined in operation S120 that none of the three situations has occurred, it is determined that it is unnecessary to perform adaptive process scheduling. Then, one (1) is set as the predetermined weight, and the process proceeds to operation S140.

In operation S130, the predetermined weight may be calculated by an experiment, and the predetermined weight has a value larger than 1 in order to reduce the delta_exe value. For example, the predetermined weight may be calculated using a formula such as “weight (W)=2̂(log10(# of process)), however, a method of calculating the predetermined weight is not necessarily limited to a numerical formula. A method of calculating the predetermined weight may be determined depending on various environmental factors such as the CPU performance or the memory capacity of the embedded device to which the scheduling method of the present invention is applied.

Finally, in operation S140, the CPU occupancy time (delta_exec) of each process is updated by applying the predetermined weight obtained in operation S130.

For example, the CPU occupancy time of each process is reduced overall using a formula such as “delta_exec←delta_exec/predetermined weight”. Then, delta_exe is added to the vruntime value of each process and accumulated.

The process of operation S110 to operation S140 corresponds to the occupancy time calculating process of the statistics update portion of the scheduler executed for each tick, and thus the same process is repeated for each tick.

While the example embodiments of the present invention and their advantages have been described in detail, it should be understood that various changes, substitutions and alterations may be made herein without departing from the scope of the invention.

What is claimed is:

1. An adaptive process scheduling method for embedded Linux, comprising:
calculating a central processing unit (CPU) occupancy time of each of one or more processes;
determining whether or not it is necessary to perform adaptive process scheduling;
calculating a predetermined weight to be applied to the CPU occupancy time of each process when it is determined that it is necessary to perform adaptive process scheduling; and
applying the predetermined weight and updating the CPU occupancy time of each process when it is determined that it is necessary to perform adaptive process scheduling.

2. The adaptive process scheduling method of claim 1, wherein the CPU occupancy time calculated in calculating the CPU occupancy time of each of one or more processes is a delta_exec value to be added to a vruntime value which a scheduler manages for each process.

3. The adaptive process scheduling method of claim 1, wherein the determining of whether or not it is necessary to perform adaptive process scheduling includes determining that it is necessary to perform adaptive process scheduling when the number of processes running on the embedded Linux abruptly increases to a predetermined number or more during a predetermined time.

4. The adaptive process scheduling method of claim 1, wherein the determining of whether or not it is necessary to perform adaptive process scheduling includes determining that it is necessary to perform adaptive process scheduling when the CPU occupancy time calculated in calculating the CPU occupancy time of each of one or more processes is equal to or lower than a predetermined critical value.

5. The adaptive process scheduling method of claim 1, wherein the determining of whether or not it is necessary to perform adaptive process scheduling includes determining that it is necessary to perform adaptive process scheduling when the number of times of non-voluntary CPU prior occupation performed on the embedded Linux increases to a predetermined number of times or more during a predetermined time.

6. The adaptive process scheduling method of claim 1, wherein the predetermined weight in updating the CPU occupancy time of each process is a value larger than one (1), and the CPU occupancy time of each process is reduced overall by dividing the CPU occupancy time calculated in calculating the CPU occupancy time of each of one or more processes by the predetermined value larger than one (1).
